(19) United States
(12) Patent Application Publication
(10) Pub. No.: US 2024/0112440 A1
(43) Pub. Date: Apr. 4, 2024

(54) METHOD AND APPARATUS FOR PROCESSING ARRAY IMAGE

(71) Applicant: SAMSUNG ELECTRONICS CO., LTD., Suwon-si (KR)

(72) Inventors: Jingu HEO, Suwon-si (KR); Byong Min KANG, Suwon-si (KR); Dong Kyung NAM, Suwon-si (KR); Yang Ho CHO, Suwon-si (KR)

(73) Assignee: SAMSUNG ELECTRONICS CO., LTD., Suwon-si (KR)

(21) Appl. No.: 18/236,635

(22) Filed: Aug. 22, 2023

(30) Foreign Application Priority Data
Sep. 22, 2022 (KR) 10-2022-0120004

(51) Int. Cl. G06V 10/75; G06T 3/40; G06T 5/00; G06T 5/50; G06T 7/13; G06V 10/25

(52) U.S. Cl. CPC G06V 10/751; G06T 3/4015; G06T 5/003; G06T 5/50; G06T 7/13; G06V 10/25; G06T 2207/10024; G06T 2207/20221

(57) ABSTRACT

A method and apparatus for array image processing are provided. The method includes receiving sub images corresponding to different views of an input array image generated through an array lens, generating temporary restored images based on the sub images using a gradient between neighboring pixels of each of the sub images, determining matching information based on a view difference between pixels of the sub images using a neural network model, based on a pixel distance between matching pairs of the pixels of the sub images using the matching information, extracting refinement targets from the matching pairs, refining the matching information by replacing at least some of target pixels included in the refinement targets based on a local search of a region based on pixel locations of the refinement targets, and generating an output image of a single view by merging the temporary restored images based on the refined matching information.

### CROSS-REFERENCE TO RELATED APPLICATIONS

This application is based on and claims the benefit of priority under 35 USC § 119(a) of Korean Patent Application No. 10-2022-0120004, filed on Sep. 22, 2022, in the Korean Intellectual Property Office, the entire disclosure of which is incorporated herein by reference for all purposes.

### BACKGROUND

### 1. Field

The disclosure relates to a method and apparatus for processing an array image.

### 2. Description of Related Art

Due to the development of optical technology and image processing technology, capturing devices are utilized in a wide range of fields such as multimedia content, security, and recognition. For example, a capturing device may be mounted on a mobile device, a camera, a vehicle, or a computer to capture an image, recognize an object, or obtain data for controlling a device. The volume of the capturing device may be determined based on the size of a lens, the focal length of the lens, and the size of a sensor. When the volume of the capturing device is limited, a long focal length may be provided in a limited space by transforming a lens structure.

### SUMMARY

According to an aspect of the disclosure, there is provided an image processing method including: receiving a plurality of sub images from an input array image generated through an array lens, each of the plurality of sub images corresponding to different views; generating a plurality of temporary restored images based on the plurality of sub images using a gradient between neighboring pixels of each of the plurality of sub images; determining matching information based on a view difference between pixels of the plurality of sub images using a neural network model; based on a pixel distance between matching pairs of the pixels of the sub images in the matching information, extracting one or more refinement targets from the matching pairs; refining the matching information to generate refined matching information by replacing at least one of target pixels in the one or more refinement targets based on a local search of a region based on pixel locations of the one or more refinement targets; and generating an output image of a single view by merging the plurality of temporary restored images based on the refined matching information.

According to another aspect of the disclosure, there is provided an image processing apparatus including: a memory configured to store instructions; and a processor configured to execute the one or more instructions to: receive a plurality of sub images from an input array image generated through an array lens, each of the plurality of sub images corresponding to different views; generate a plurality of temporary restored images based on the plurality of sub images using a gradient between neighboring pixels of each of the plurality of sub images; determine matching information based on a view difference between pixels of the plurality of sub images using a neural network model; based on a pixel distance between matching pairs of the pixels of the sub images in the matching information, extract one or more refinement targets from the matching pairs; refine the matching information to generate refined matching information by replacing at least one of target pixels in the one or more refinement targets based on a local search of a region based on pixel locations of the one or more refinement targets; and generate an output image of a single view by merging the plurality of temporary restored images based on the refined matching information.

According to another aspect of the disclosure, there is provided an electronic device including: an imaging device configured to generate an input array image comprising a plurality of sub images, each of the plurality of sub images corresponding to different views; and a processor configured to: generate a plurality of temporary restored images based on the plurality of sub images using a gradient between neighboring pixels of each of the plurality of sub images, determine matching information based on a view difference between pixels of the plurality of sub images using a neural network model; based on a pixel distance between matching pairs of the pixels of the sub images in the matching information, extract one or more refinement targets from the matching pairs; refine the matching information to generate refined matching information by replacing at least one of target pixels in the one or more refinement targets based on a local search of a region based on pixel locations of the one or more refinement targets; and generate an output image of a single view by merging the plurality of temporary restored images based on the refined matching information.

Other features and aspects will be apparent from the following detailed description, the drawings, and the claims.

### BRIEF DESCRIPTION OF THE DRAWINGS

FIG. 1A illustrates an example of configurations and operations of an imaging device and an image processing apparatus, according to one or more example embodiments.

FIG. 1B illustrates an example of a configuration of the imaging device, according to one or more example embodiments.

FIG. 2 illustrates an example of pixels of an input array image, according to one or more example embodiments.

FIG. 3 illustrates an example of a change in pixel data from raw data to an output image, according to one or more example embodiments.

FIG. 4A illustrates an example of a demosaicing operation based on region of interest (ROI) detection, according to one or more example embodiments.

FIG. 4B illustrates an example of an operation of determining a gradient value, according to one or more example embodiments.

FIG. 5 illustrates an example of an upsampling operation based on edge information, according to one or more example embodiments.

FIG. 6 illustrates an example of a change in pixel data during upsampling, according to one or more example embodiments.

FIG. 7 illustrates an example of a sharpening operation according to one or more example embodiments.

FIG. 8 illustrates an example of a matching information refinement operation using an optical flow, according to one or more example embodiments.

FIG. 9 illustrates an example of a pixel merging operation based on matching information, according to one or more example embodiments.

FIG. 10 illustrates an example of a changing process of an original copy of a G channel, according to one or more example embodiments.

FIG. 11 illustrates an example of an array image processing process according to one or more example embodiments.

FIG. 12 illustrates an example of a configuration of an image processing apparatus according to one or more example embodiments.

FIG. 13 illustrates an example of a configuration of an electronic device according to one or more example embodiments.

FIG. 14 illustrates an example of an image processing method according to one or more example embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed structural or functional description is provided as an example only and various alterations and modifications may be made to the examples. Here, the examples are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “Joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, “at least one of A and B”, “at least one of A, B, or C,” and the like, each of which may include any one of the items listed together in the corresponding one of the phrases, or all possible combinations thereof.

Unless otherwise defined, all terms used herein including technical or scientific terms have the same meaning as commonly understood by one of ordinary skill in the art to which examples belong. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, examples will be described in detail with reference to the accompanying drawings. When describing the examples with reference to the accompanying drawings, like reference numerals refer to like components and a repeated description related thereto will be omitted.

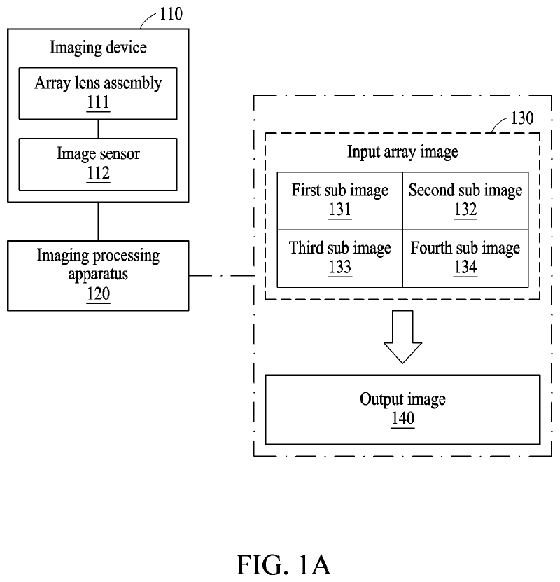

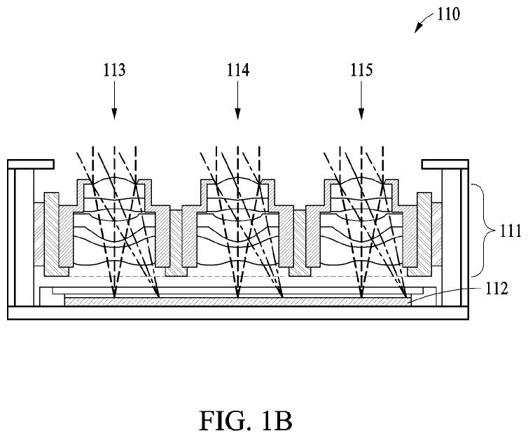

FIG. 1A illustrates configurations and operations of an imaging device and an image processing apparatus, according to one or more example embodiments. Referring to FIG. 1A, an imaging device 110 may include an array lens assembly 111 and an image sensor 112. The array lens assembly 111 may include a layer of at least one lens array. Each layer may include a lens array including a plurality of individual lenses. For example, a lens array may include individual lenses arranged in an array. For example, the lens array may include individual lenses arranged in a 2*2 array or a 3*3 array. However, the disclosure is not limited to a 2*2 array or a 3*3 array, and as such, according to another example embodiment, the lens array may have a different configuration. Each layer may include the same lens arrangement.

The image sensor 112 may be a single image sensor or multiple image sensors provided in a number corresponding to the lens arrangement. The image sensor 112 may generate an input array image 130. The input array image 130 may include a first sub image 131, a second sub image 132, a third sub image 133 and a fourth sub image 134 based on the lens arrangement of the array lens assembly 111. The first sub image 131, the second sub image 132, the third sub image 133 and the fourth sub image 134 in a 2*2 arrangement are based on an assumption that the array lens assembly 111 has a 2*2 lens arrangement. Hereinafter, an example of the array lens assembly 111 in the 2*2 lens arrangement is described. However, the lens arrangement of the array lens assembly 111 is not limited to 2*2.

The image processing apparatus 120 may generate an output image 140 by merging the first sub image 131, the second sub image 132, the third sub image 133 and the fourth sub image 134. The output image 140 may have higher image quality than each of the first sub image 131, the second sub image 132, the third sub image 133 and the fourth sub image 134. For example, the output image 140 may have 4 times the image resolution of each of the first sub image 131, the second sub image 132, the third sub image 133 and the fourth sub image 134. The image processing apparatus 120 may maximize the resolution of the output image 140 by optimizing individual processing of the first sub image 131, the second sub image 132, the third sub image 133 and the fourth sub image 134 and/or optimizing merging processing of the first sub image 131, the second sub image 132, the third sub image 133 and the fourth sub image 134.

FIG. 1B illustrates an example of a configuration of the imaging device, according to one or more example embodiments. Referring to FIG. 1B, the imaging device 110 may include the array lens assembly 111 and the image sensor 112. The imaging device 110 may include a plurality of apertures. For example, the imaging device 110 may include a first aperture 113, a second aperture 114 and a third aperture 115. However, the disclosure is not limited thereto, and as such, according to another example embodiment, the imaging device 110 may include more than three apertures or less than three apertures. The imaging device 110 may generate sub images based on the arrangement of the plurality of apertures 113 to 115. FIG. 1B illustrates an example of a lens arrangement in a 3*3 array type. In this example, 3*3 sub images may be obtained. However, 3*3 is merely an example, and a different array type, such as 2*2, may be used. The imaging device 110 may correspond to an array lens device. An array lens technique is a technique for obtaining a plurality of small images having the same angle of view using a camera including a plurality of lenses having a short focal length. The thickness of a camera module may decrease through the array lens technique.

An array lens may be used in various technical fields. The array lens may reduce the size of a camera by dividing a large sensor and a large lens for a large sensor into an array type. For example, when the length (in other words, the height) of a first camera is L based on an assumption that an angle of view is A, a focal length is f, and an image size is D, the length of a second camera based on an assumption that an angle of view is A, a focal length is f/2, and the image size is D/2 may decrease to L/2. The resolution of the second camera may decrease to ¼ compared to the first camera. When the second camera is configured by a 2*2 lens array and one output image is generated, the resolution may be the same as the first camera. More specifically, 4 sub images may be generated by the 2*2 lens array and an image having the same resolution as the first camera may be derived by synthesizing the four sub images.

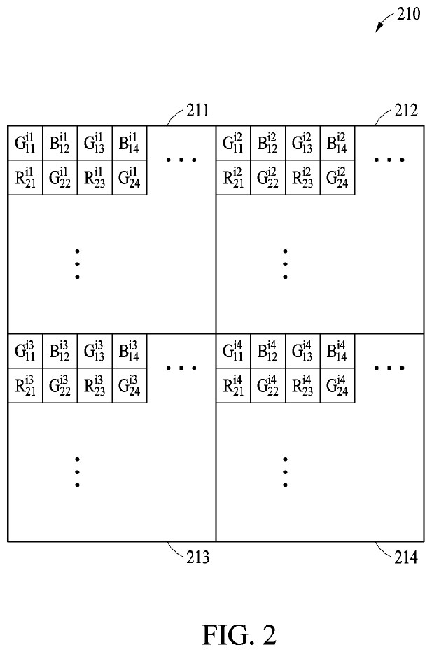

FIG. 2 illustrates an example of pixels of an input array image, according to one or more example embodiments. Referring to FIG. 2, an input array image 210 may include a first sub image 211, a second sub image 212, a third sub image 213 and a fourth sub image 214. The input array image 210 may include a red (R) channel signal, a green (G) channel signal, and a blue (B) channel signal. A color filter array (CFA) may be between a lens and an image sensor and a signal of each channel may be divided through the CFA. Each of the first sub image 211, the second sub image 212, the third sub image 213 and the fourth sub image 214 of the input array image 210 may include image data in a pattern (e.g., a 2*2 array pattern) corresponding to a pattern of the CFA (e.g., a 2*2 array pattern). Hereinafter, an example that the CFA includes a Bayer pattern is described, however, different patterns other than the Bayer pattern may be used. In this example, the input array image 210 may include image data based on an R-G-G-B 2*2 Bayer pattern. As illustrated in FIG. 2, a pixel of each channel may be represented by Rₘₙ^{ik}, Gₘₙ^{ik}, and Bₘₙ^{ik}. Here, k may denote an identifier of a sub image where each pixel belongs to and m and n may denote an identifier of a location in a sub image where each pixel belongs to. Data including an R channel signal, a G channel signal, and a B channel signal, such as the input array image 210, may be referred to as raw data. Each channel signal of the raw data may be separated from another and may constitute individual channel data, such as R channel data, G channel data, and B channel data. In each individual channel data, a different channel pixel may be filled through demosaicing.

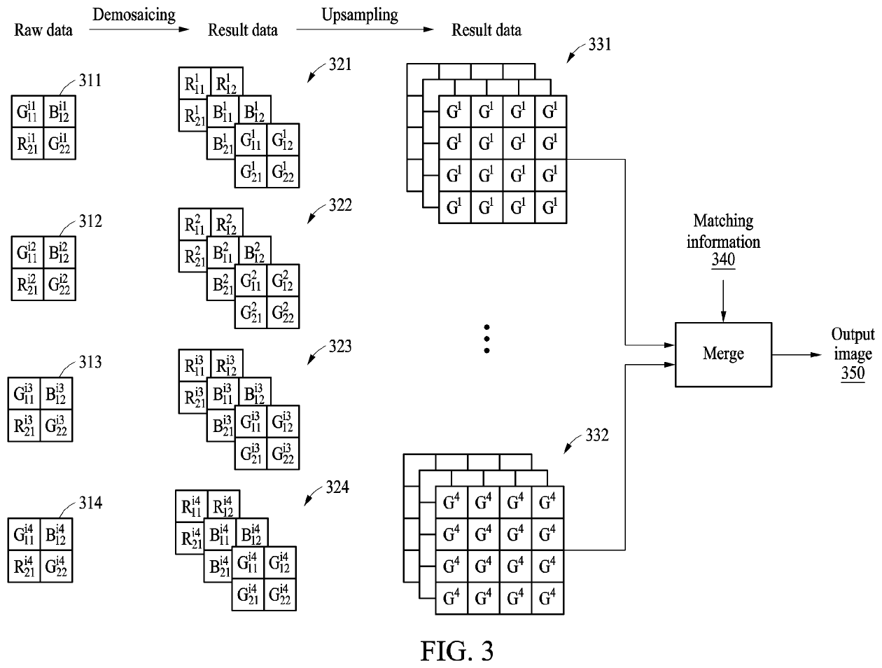

FIG. 3 illustrates an example of a change in pixel data from raw data to an output image, according to one or more example embodiments. Referring to FIG. 3, result data 321 to 324 may be determined through demosaicing each individual piece of channel data of raw data 311 to 314. For example, first result data 321 may be determined through demosaicing individual piece of channel data of first raw data 311, second result data 322 may be determined through demosaicing individual piece of channel data of first raw data 312, third result data 323 may be determined through demosaicing individual piece of channel data of first raw data 313 and fourth result data 324 may be determined through demosaicing individual piece of channel data of first raw data 314. As representatives of the raw data 311 to 314, four pixels of each sub image are illustrated in FIG. 3. Each pixel of the raw data 311 to 314 may be represented by Rₘₙ^{ik}, Gₘₙ^{ik}, and Bₘₙ^{ik}. k may denote an identifier of a sub image where each pixel belongs to and m and n may denote an identifier of a location in a sub image where each pixel belongs to.

The raw data 311 to 314 may be divided into individual pieces of channel data and a different channel pixel of each of the individual piece of channel data may be filled by interpolation based on demosaicing. Although a detailed description is provided below, based on demosaicing of the examples, pixels in which a G channel signal is dominant may be classified into a region of interest (ROI) and different interpolations may apply to an ROI and a region of non-interest (RONI). Through such interpolation on the ROI, the resolution of a special region, such as a moire region, may enhance. The result data 321 to 324 may be constituted by each individual piece of channel data and may correspond to an RGB full color image. A pixel of R channel data, a pixel of G channel data, and a pixel of B channel data may be represented by Rₘₙ^{k}, Gₘₙ^{k}, and Bₘₙ^{k}, respectively. Here, k may denote an identifier of a sub image and m and n may denote an identifier of a location in individual piece of channel data where each pixel belongs to.

According to an example embodiment, upsampled result data may be determined through upsampling the result data 321 to 324 of demosaicing. FIG. 3 illustrates that first upsampled result data 331 may be determined through upsampling the result data 321 of a first sub image and fourth upsampled result data 332 may be determined through upsampling the result data 324 of a fourth sub image. However, the disclosure is not limited thereto, and as such, second upsampled result data of a second sub image and third upsampled result data of a third sub image may be further determined using result data 322 and result data 323. The resolution may be enhanced through upsampling. The degree of enhancement may be determined based on the number of sub images included in an input array image. For example, when the input array image includes 2*2 sub images, the resolution of the result data 331 and 332 may be four times of the result data 321 to 324.

Although a detailed description is provided below, upsampling of the examples may be performed based on edge information generated during demosaicing. Through this process, unnecessary redundant operations may be removed and an edge portion may be restored with high resolution. Pixels of the result data 331 and 332 may be represented by G^{k}, R^{k}, and B^{k}. Although a location identifier is omitted in FIG. 3 for convenience, location identifiers m and n may be added, such as the raw data 311 to 314 and the result data 321 to 324. According to an example embodiment, sharpening may be additionally performed after upsampling.

The first upsampled result data 331 and the second upsampled result data 332 may have higher resolution than the result data 321 to 324. However, the first upsampled result data 331 and the second upsampled result data 332 may include an artifact due to lack of information suitable for the enhanced resolution. The sub images may correspond to different views and sharpness suitable for the enhanced resolution may be achieved as the first upsampled result data 331 and the second upsampled result data 332 based on the sub images is merged based on matching information 340. In this aspect, the first upsampled result data 331 and the second upsampled result data 332 may be referred to as a temporary restored image and an output image 350 may be referred to as a final restored image.

Although a detailed description is provided below, the matching information 340 may be determined based on an optical flow. The optical flow may be determined by using a neural network model and may include the matching information 340 based on a view difference of the sub images of pixels in the sub images. The optical flow may represent a difference between pixel locations based on a view difference rather than a difference between pixel locations based on a movement over time. The matching information 340 may represent a matching pair of the sub images. For example, when a same point in the real world is captured as a first pixel of a first sub image and a second pixel of a second sub image, the matching information 340 may include the first pixel and the second pixel as a matching pair. Although an example that one matching pair matches pixels of two sub images is described below, one matching pair may be defined to match pixels of three sub images or four sub images. The neural network model may be pretrained to output an optical flow including the matching information 340 in response to an input of input data based on the sub images.

Through the matching information 340, the first upsampled result data 331 based on the sub images corresponding to different views may be merged into the output image 350 corresponding to a single view. The resolutions of the sub images may be enhanced by upsampling and the matching information 340 may represent a matching relationship between pixels based on the enhanced resolution. The resolutions of the sub images may be referred to as a low resolution and an upsampling result may be referred to as a high resolution. In this example, the neural network model may be trained to estimate an optical flow of high-resolution output data based on high-resolution input data, may be trained to estimate an optical flow of high-resolution output data based on low-resolution input data, or may be trained to estimate an optical flow of low-resolution output data based on low-resolution input data. According to an example embodiment, the optical flow of low-resolution output data may be converted into high resolution through a resolution enhancement operation, such as upsampling.

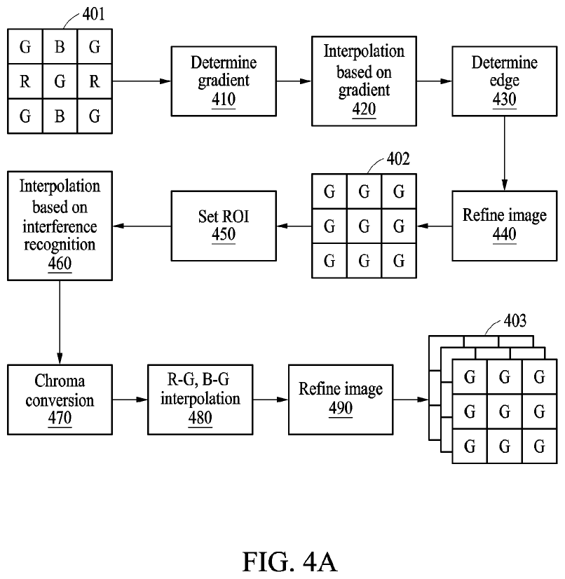

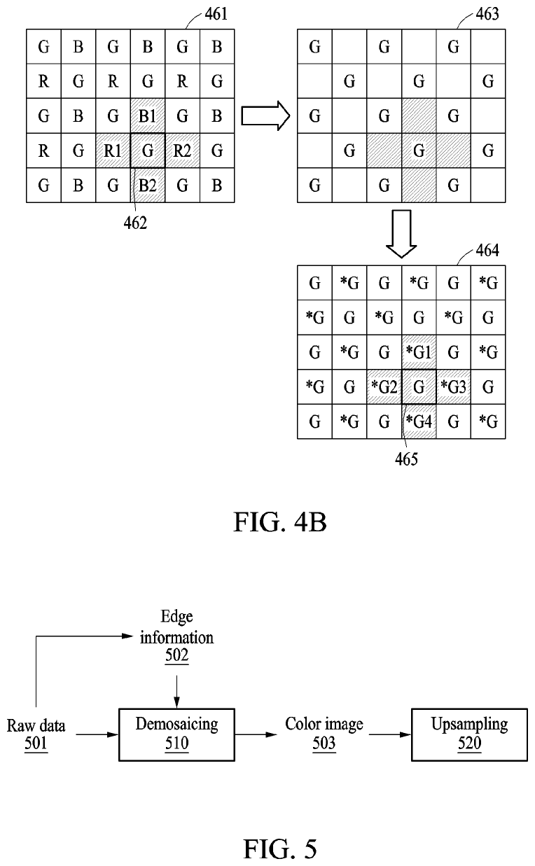

FIG. 4A illustrates an example of a demosaicing operation based on ROI detection, according to one or more example embodiments. Referring to FIG. 4A, temporary G channel data 402 may be determined based on raw data 401 through operations 410 to 440. In operation 410, a gradient may be determined based on the raw data 401. For example, G channel pixels may be extracted from the raw data 401 and for an empty space between the G channel pixels, a gradient in the vertical direction and a gradient in the horizontal direction may be determined. Here, the empty spaces between the G channel pixels may be a space where R channel pixels and B channel pixels exist in the raw data 401.

In operation 420, gradient-based interpolation may be performed. Interpolation may be performed in a smaller direction of the gradient in the vertical direction and the gradient in the horizontal direction. A gradient value in each direction and an interpolation value of a target pixel may be calculated in various ways. For example, when values of 3*3 grid cells are defined as C₁₁ to C₃₃, a gradient value V in the vertical direction of C₂₂ may be determined through C₁₂ to C₃₂ and a gradient value H in the horizontal direction of C₂ may be determined through C₂₁ to C₂₃. When V is greater than H, it may be determined that C₂=H/2. When V is less than H, it may be determined that C₂₂=V/2. However, various interpolation methods may exist.

In operation 430, edge information may be determined and in operation 440, image refinement may be performed. Operations 430 and 440 may apply to G channel data and the temporary G channel data 402 may be determined through operations 430 and 440. The edge information may include the gradient value and a Laplacian value. The gradient value may be a primary derivative value determined based on a neighboring pixel value of operation 420 and the Laplacian value may be a secondary derivative value determined based on a neighboring pixel value of a neighboring pixel. Since there is no original G channel information in a space two pixels apart from a space between the original G channel pixels (in other words, a space where the R channel pixels and the B channel pixels exist in the raw data 401), R channel information or B channel information may be used as the original G channel information when obtaining the Laplacian value. For example, image refinement may include interpolation in a diagonal direction using edge information in the diagonal direction. In this example, interpolation may represent refinement through interpolation.

When the temporary G channel data 402 is determined, final color data 403 may be determined through operations 450 to 490. The final color data 403 may include final R channel data, final G channel data, and final B channel data.

In operation 450, an ROI may be set. The ROI may be set in the temporary G channel data 402. The ROI may include an interference region where an artifact may highly occur, such as a moire region. The ROI may be set based on pixels in which a G channel signal is dominant among the R channel signal, G channel signal, and B channel signal. Whether the G channel signal is dominant may be determined based on a difference between a first gradient value of a predetermined pixel location of the temporary G channel data 402 and a second gradient value of a corresponding pixel location of the raw data 401. For example, when the difference is less than a threshold, it may be determined that the G channel signal is dominant at the corresponding pixel location. For example, it may be assumed that the raw data 401 belongs to a first sub image of the sub images. A first gradient value based on an interpolation result using a G channel signal around a first pixel of the first sub image and a second gradient value based on an R channel signal and a B channel signal around the first pixel may be determined. In this example, the interpolation result using a G channel signal may represent the temporary G channel data 402. When a difference between the first gradient value and the second gradient value is less than a threshold, the ROI may be set based on the first pixel.

In operation 460, interpolation based on interference recognition on the temporary G channel data 402 may be performed. Interpolation based on interference recognition may include forward interpolation and cross interpolation. The forward interpolation may be interpolation in the smaller gradient direction, as described in operation 420. The cross interpolation may be interpolation in the vertical direction with respect to the forward interpolation. In other words, the cross interpolation may be interpolation in the greater gradient direction. For example, in the example of the 3*3 grid described above, it may be determined that when V>H, C₂₂=V/2 and when V<H, C₂₂=H/2. In this example, interpolation may represent refinement through interpolation. Such interpolation may suppress an artifact while maintaining an edge of an ROI, such as a moire region. A result of operation 460 may correspond to final G channel data.

In operation 470, R-G channel data and B-G channel data may be determined through chroma conversion. According to an example, operation 470 may be performed before operation 460 or operation 450. The R-G channel data may be determined by subtracting each pixel value of final R channel data from each pixel value of R channel data extracted from the raw data 401. The B-G channel data may be determined by subtracting each pixel value of final R channel data from each pixel value of R channel data extracted from the raw data 401.

In operation 480, interpolation may be performed on the R-G channel data and the B-G channel data. Interpolation of operation 480 may correspond to interpolation of operations 410 and 420. For the R-G channel data, interpolation in the smaller gradient direction may be performed on pixels other than R-G pixels and for the B-G channel data, interpolation in the smaller gradient direction may be performed on pixels other than B-G pixels. Then, temporary R channel data and temporary B channel data may be determined by adding final R channel data to the R-G channel data and the B-G channel data. The final R channel data and final B channel data may be determined by applying image refinement of operation 490 to the temporary R channel data and the temporary B channel data. The final color data 403 including the final R channel data, the final G channel data, and the final B channel data may correspond to a demosaicing result.

FIG. 4B illustrates an example of an operation of determining a gradient value, according to one or more example embodiments. Referring to FIG. 4B, G channel data 463 may be extracted from raw data 461 including an R channel signal, a G channel signal, and a B channel signal. Temporary G channel data 464 may be determined through gradient-based interpolation (e.g., interpolation of operation 420 of FIG. 4A) on the G channel data 463. In the temporary G channel data 464, a symbol * may be displayed on a pixel generated by interpolation. A first pixel 462 of the raw data 461 may exist at the same location as a second pixel 465 of the temporary R channel data 464. The location may be referred to as a target pixel location.

Whether the target pixel location is included in the ROI may be determined through a comparison between a first gradient value based on interpolation using the temporary R channel data 464 and a second gradient value based on interpolation using the raw data 461. The first gradient value may be determined based on a gradient in the vertical direction using *G1 and *G4 of the temporary R channel data 464 and a gradient in the horizontal direction using *G2 and *G3. For example, a sum of absolute values of two gradient values may be determined to be the first gradient value. The second gradient value may be determined based on a gradient in the vertical direction using B1 and B2 of the raw data 461 and a gradient in the horizontal direction using R1 and R2. For example, a sum of absolute values of two gradient values may be determined to be the second gradient value. When the difference between the first gradient value and the second gradient value is less than a threshold, the ROI may be set such that a target location of a second pixel 465 is included in the ROI. By the same way, it may be determined whether other pixels of the temporary R channel data 464 are included in the ROI.

The example of using the R-G-G-B Bayer pattern as the CFA is described with reference to FIGS. 4A and 4B. According to an example, a different pattern may be used as a CFA. For example, instead of an R-G-G-B arrangement, a different pattern arranged in a first channel signal—a second channel signal—the second channel signal—a third channel signal may be used. In this example, the order of channel signals may correspond to the upper left, upper right, lower left, and lower right of a 2*2 array of the CFA, respectively, For example, an R-C-C-B arrangement, a Cy-Y-Y-M arrangement, and a Cy-Y-Y-R arrangement may be used. In this example, C may denote a clear (C) channel signal, Cy may denote a cyan (Cy) channel signal, Y may denote a yellow (Y) channel signal, and M may denote a magenta (M) channel signal. The second channel signal, which is a dominant color, may be used as G channel data in the Bayer pattern example. For example, when using an R-C-C-B pattern instead of the Bayer pattern, temporary C channel data may be generated in response to a C channel signal and final C channel data may be determined through interference recognition interpolation based on the temporary C channel data. Then, final R channel data and final B channel data may be determined through interpolation on R-C channel data and B-C channel data. Demosaicing in a similar manner may apply to other patterns.

FIG. 5 illustrates an example of an upsampling operation based on edge information, according to one or more example embodiments. Referring to FIG. 5, edge information 502 may be generated based on raw data 501. For example, the edge information 502 may include a gradient value and a Laplacian value. Demosaicing 510 may be performed on the raw data 501 based on the edge information 502 and a color image 503 may be generated based on the demosaicing 510. The edge information 502 may be used for upsampling 520 the color image 503. Through this process, unnecessary redundant operations may be removed and an edge portion may be restored with high resolution.

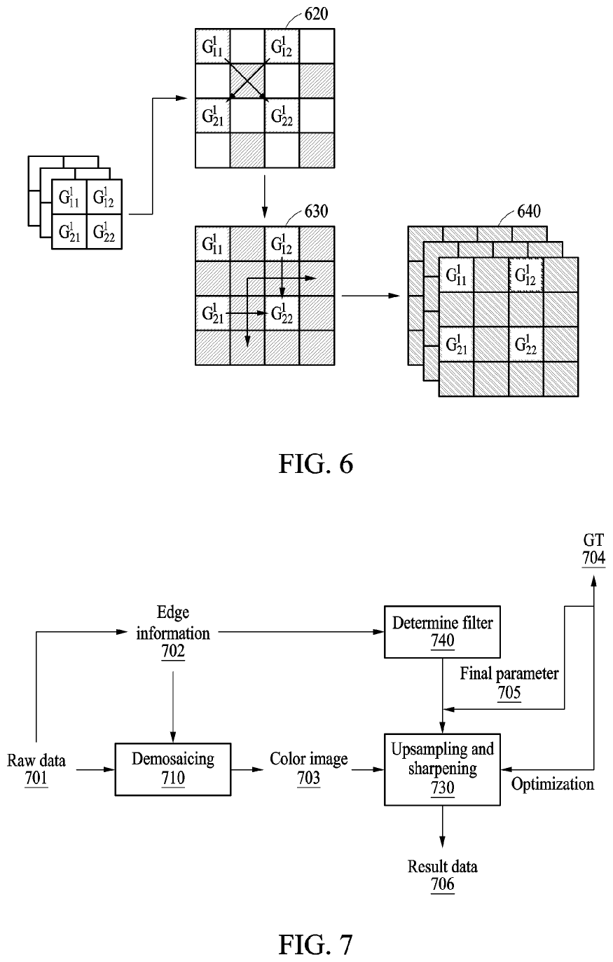

FIG. 6 illustrates an example of a change in pixel data during upsampling, according to one or more example embodiments. Referring to FIG. 6, at least some regions of first intermediate data 620 may be filled through interpolation in the diagonal direction on G channel data and at least some regions of second intermediate data 630 may be filled through interpolation in the vertical and horizontal directions on the first intermediate data 620. In this example, edge information may be used in each interpolation. An upsampling result 640 may be determined by iteratively performing interpolation on the first intermediate data 620 and/or the second intermediate data 630.

FIG. 7 illustrates an example of a sharpening operation according to one or more example embodiments. Referring to FIG. 7, edge information 702 may be generated based on raw data 701, demosaicing 710 may be performed on the raw data 701 based on the edge information 702, and a color image 703 may be generated in response to the demosaicing 710. The edge information 702 may be used for filter determination based on operation 740. For example, a Laplacian filter based on Laplacian values of the edge information 702 may be determined to be a sharpening filter. Of upsampling and sharpening 730, sharpening may be performed using the sharpening filter. The sharpening filter may apply to an upsampling result of the upsampling and sharpening 730 based on a sharpening parameter. The description of FIG. 6 may apply to upsampling of the upsampling of the sharpening 730.

When the sharpening result is derived, the sharpening parameter may be adjusted based on a difference between the sharpening result and a target image. The sharpening parameter may be adjusted to reduce the difference between the sharpening result and the target image. For example, the sharpening parameter may include at least one of the size of a filter kernel, the shape of the filter kernel, and a sharpening amount. The shape of the filter kernel may be determined in operation 740. The target image may correspond to ground truth (GT) 704. When a goal of optimization is fixed to achieving the highest resolution, the GT 704 may be unambiguously determined. For example, the GT 704 may be a chart image for image quality evaluation that is captured through a single lens camera instead of an array lens camera. When the difference between the sharpening result and the target image is less than a threshold through an optimization process, the sharpening parameter may be determined to be a final parameter 705 and result data 706 may be determined based on sharpening based on the final parameter 705. For example, the result data 706 may correspond to the result data 331 and 332 of FIG. 3.

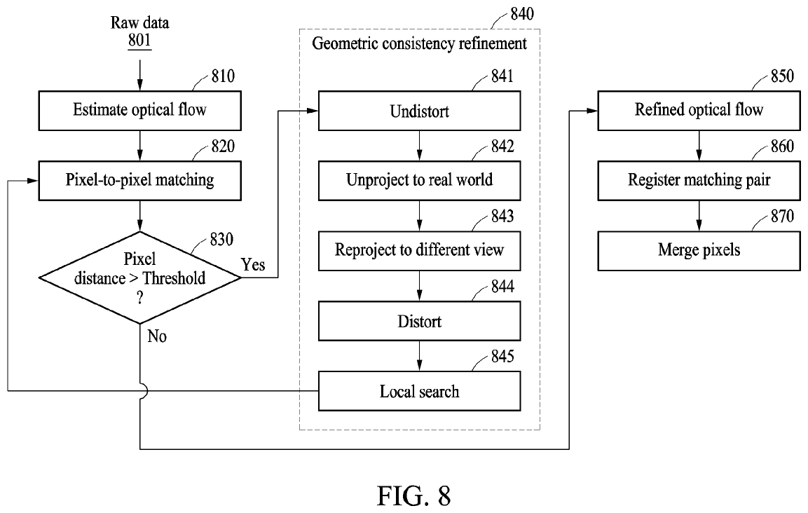

FIG. 8 illustrates an example of a matching information refinement operation using an optical flow, according to one or more example embodiments. Referring to FIG. 8, in operation 810, an optical flow may be estimated using a neural network model. The optical view may include matching information based on a view difference between sub images of pixels. The optical flow may represent a difference between pixel locations based on a view difference rather than a difference between pixel locations based on a movement over time. In operation 820, pixel-to-pixel matching may be performed based on the matching information. In operation 830, a pixel distance based on the matching result may be compared to a threshold. The pixel distance may represent a distance between target pixels of a matching pair. When a pixel distance of a matching pair is greater than the threshold, the matching pair may be extracted as a refinement target and geometric consistency refinement 840 may be applied to the matching pair.

The geometric consistency refinement 840 may include operations 841 to 845. Hereinafter, an example of the geometric consistency refinement 840 on a first refinement target including a first pixel of a first temporary restored image and a second pixel of a second temporary restored image is described.

In operation 841, undistortion may be performed on the first pixel. In operation 842, an undistortion result may be unprojected to the real world. The undistortion and unprojection may be performed based on a first calibration parameter. For example, undistortion may be based on a first intrinsic parameter and unprojection may be based on a first extrinsic parameter (e.g., a rotation parameter and a translation parameter). Through operations 841 and 842, a corresponding pixel of the real world corresponding to the first pixel of the first temporary restored image may be determined.

In operation 843, the corresponding pixel may be reprojected to a different view. In operation 844, distortion may be performed on a reprojection result. The reprojection and distortion may be based on a second calibration parameter. For example, reprojection may be based on a second extrinsic parameter (e.g., a rotation parameter and a translation parameter) and distortion may be based on a second intrinsic parameter. Through operations 843 and 844, a temporary pixel of the second temporary restored image corresponding to a corresponding pixel of the real world may be determined.

In operation 845, a local search may be performed based on a location of the temporary pixel in the second temporary image. The matching information may be refined by replacing at least some of target pixels included in the refinement targets based on the local search. Through the local search, for a predetermined range, a search in a predetermined manner may be performed. A new second pixel of the second temporary restored image may be determined through the local search. A matching target of the first pixel of the first refinement target may be updated to the new second pixel.

An array lens camera may be divided into sub camera elements based on involvement of generation of sub images. A calibration parameter may have a different parameter value for a different sub camera element. For example, when a first sub image is generated through a first lens assembly of an array lens assembly and a second sub image is generated through a second lens assembly of the array lens assembly, the first lens assembly and the second lens assembly may be different sub camera elements and different parameter values thereof may be derived. In the example described above, when the first temporary restored image is based on the first sub image, the first calibration parameter, the first intrinsic parameter, and the first extrinsic parameter may be derived for the first lens assembly. When the second temporary restored image is based on the second sub image, the second calibration parameter, the second intrinsic parameter, and the second extrinsic parameter may be derived for the second lens assembly.

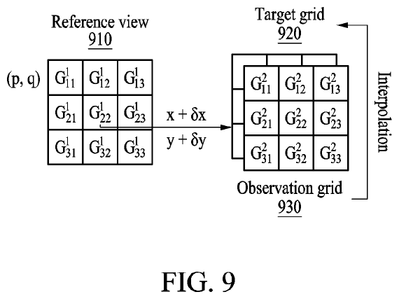

When the geometric consistency refinement 840 is finished, operation 820 may be performed again. The pixel matching of operation 820 and the geometric consistency refinement 840 may be repeated until pixel distances of all matching pairs decrease to be less than a threshold. When the pixel distances of all matching pairs are less than the threshold, a refined optical flow may be determined in operation 850. In this example, refinement may represent the geometric consistency refinement 840. In operation 860, a matching pair based on the refined optical flow may be registered and in operation 870, pixel merging may be performed. A detailed description of pixel merging is provided with reference to FIG. 9.

FIG. 9 illustrates an example of a pixel merging operation based on matching information, according to one or more example embodiments. Referring to FIG. 9, any one of views of sub images may be designated as a reference view 910. Among temporary restored images, a temporary restored image having the reference view 910 may be referred to as a reference image. The temporary restored images may be merged based on the reference image. Each pixel of an output image may be determined based on a weighted sum of each pixel of the other images of the temporary restored images and matching pixels of the remaining images of the temporary restored images. The matching information may be determined by refined matching information. For example, a weighted sum of a first pixel of the reference image and a second pixel of the other image may be determined based on at least one of a first weight based on a difference between an intensity of the first pixel and an intensity of the second pixel, a second weight based on a pixel distance between the first pixel and the second pixel, and a third weight based on whether the first pixel and the second pixel correspond to raw data.

The weighted sum may be performed based on bilateral filtering. The bilateral filtering may include self bilateral filtering and cross bilateral filtering. According to an example, pixel merging may be performed through self bilateral filtering and/or cross bilateral filtering. Based on self bilateral filtering, in one view, a pixel and surrounding pixels may be merged. Self bilateral filtering may be performed through Equations 1 to 4 shown below. Equation 1 shown below may represent a weight based on a pixel intensity difference of the reference view 910. The pixel intensity may represent a pixel value.

$$\\ \begin{matrix}{w}_{pq \_ 22}^{1} = exp ( - \frac{{( {G}_{pq}^{1} - {G}_{22}^{1} )}^{2}}{{σ}^{2}} ) & [ Equation 1 ]\end{matrix}$$

In Equation 1, w_{pq_22}¹ may denote a weight based on a pixel intensity difference between G_{pq}¹ and G₂₂¹, G₂₂¹ may denote a pixel intensity of a center pixel, G_{pq}¹ may denote a pixel intensity of a neighboring pixel of G₂₂¹, and σ may denote a standard deviation. As illustrated in FIG. 9, p and q may have values of 1 to 3, respectively. G_{pq}¹ may include G₂₂¹. According to Equation 1, as the pixel intensity difference decreases, the weight may increase.

Equation 2 shown below may represent a weight based on a pixel distance of the reference view 910.

$$\\ \begin{matrix}{w}_{d \_ 22}^{1} = exp ( - \frac{{D ( {G}_{pq}^{1} - {G}_{22}^{1} )}^{2}}{{σ}^{2}} ) & [ Equation 2 ]\end{matrix}$$

In Equation 2, w_{d_22}¹ may denote a weight based on a distance between G₂₂¹ and G_{pq}¹, D(G_{pq}¹−G₂₂¹) may denote a distance between G_{pq}¹ and G₂₂¹, and σ may denote a standard deviation. According to Equation 2, as the distance decreases, the weight may increase.

Equation 3 shown below may represent a fusion weight based on a pixel distance and a difference of pixel intensities of the reference view 910.

w_{pq_d}¹=w_{pq_22}¹*w_{d_22}¹ [Equation 3]

In Equation 3, w_{pq_d}¹ may denote a fusion weight. A neighboring pixel may be selected by (p, q).

Equation 4 shown below may represent a pixel merging result of the reference view 910 based on the fusion weight of the reference view 910.

$$\\ \begin{matrix}{G}_{22}^{1} = \frac{{\sum }_{p , q} {G}_{p , q}^{1} * {w}_{pq\_d}^{1}}{{\sum }_{p , q} {w}_{pq\_d}^{1}} & [ Equation 4 ]\end{matrix}$$

In Equation 4, 22 may denote a merged pixel value of the reference view 910, G_{p,q}¹ may denote a pixel of the reference view 910 selected by (p, q), and w_{pq_d}¹ may denote a fusion weight of the selected pixel. p and q may have values of 1 to 3, respectively. Through transformation of Equations 1 to 4, a weight and a pixel merging result of other views may be determined.

Based on cross bilateral filtering, each pixel of a predetermined view and a corresponding pixel of a different view may be merged. The corresponding pixel may be determined through matching information. Referring to FIG. 9, G channel data of a temporary restored image of the reference view 910 may be converted into G channel data of an observation grid 930 through the matching information. For example, the reference view 910 may correspond to a first view of a first sub image and the observation grid 930 may correspond to a second view of a second sub image. A pixel (x, y) of the G channel data of the reference view 910 may be converted into a pixel (x+δx, y+δy) of the G channel data of the observation grid 930 through matching information of (δx, δy).

When δx or δy is not an integer, the pixel (x+δx, y+δy) may not match with predetermined coordinates. According to examples, cross bilateral filtering may be performed while assuming a target grid 920 based on integers δx and δy and a difference between the target grid 920 and the observation grid 930 may be covered through interpolation using a weight. Such cross bilateral filtering may be performed through Equations 5 to 8 shown below. Equation 5 shown below may represent a weight based on a pixel intensity difference of the reference view 910 and a second view of the observation grid 930.

$$\\ \begin{matrix}{w}_{i \_ 22}^{1 \_ 2} = exp ( - \frac{{( {G}_{22}^{2} - {G}_{22}^{1} )}^{2}}{{σ}^{2}} ) & [ Equation 5 ]\end{matrix}$$

In Equation 1, w_{i_22}^{1_2} may denote a weight based on a pixel intensity difference between G₂₂² and G₂₂¹, G₂₂¹ may denote a pixel intensity of a predetermined pixel of the reference view 910, G₂₂² may denote a pixel intensity of a corresponding pixel of the second view, and σ may denote a standard deviation. The corresponding pixel may be determined through matching information. According to Equation 5, as the pixel intensity difference decreases, the weight may increase.

Equation 6 shown below may represent a weight based on a pixel distance of the second view of the observation grid 930 and the reference view 910.

$$\\ \begin{matrix}{w}_{d \_ 22}^{1 \_ 2} = exp ( - \frac{{D ( {G}_{22}^{2} - {G}_{22}^{1} )}^{2}}{{σ}^{2}} ) & [ Equation 6 ]\end{matrix}$$

In Equation 6, w_{d_22}^{1_2} may denote a weight based on a distance between G₂₂² and G₂₂¹, D(G₂₂²−G₂₂¹) may denote a distance between G₂₂² and G₂₂¹ and σ may denote a standard deviation. In cross bilateral filtering, a function D may output a value close to “0” as a distance value decreases and the distance value is close to an integer value obtained by rounding down the distance value. According to Equation 6, as the distance decreases and the distance is close to an integer, the weight may increase.

Equation 7 shown below may represent a fusion weight based on a pixel distance and a pixel intensity difference of the second view of the observation grid 930 and the reference view 910.

w_{i_d}^{1_2}=w_{i_22}^{1_2}*w_{d_22}^{1_2} [Equation 7]

In Equation 7, w_{i_d}^{1_2} may denote a fusion weight.

Equation 8 shown below may represent a pixel merging result of the reference view 910 based on the fusion weight.

$$\\ \begin{matrix}{G}_{22}^{1 \_ final} = \frac{{\sum }_{i} {G}_{i}^{1} \cdot {w}_{i\_d}^{1 \_ i}}{{\sum }_{i} {w}_{i\_d}^{1 \_ i}} & [ Equation 8 ]\end{matrix}$$

In Equation 4, G₂₂^{1_final} may denote a merged pixel value of the reference view 910, Gᵢ¹ may denote a pixel of each view selected by i, and w_{i_d}^{1_i} may denote a fusion weight of the selected pixel. i may denote an identifier of a view. For example, in the case of four sub images, i may have a value of 1 to 4. A fusion weight associated with a third view and a fourth view may be obtained by transforming Equations 5 to 7.

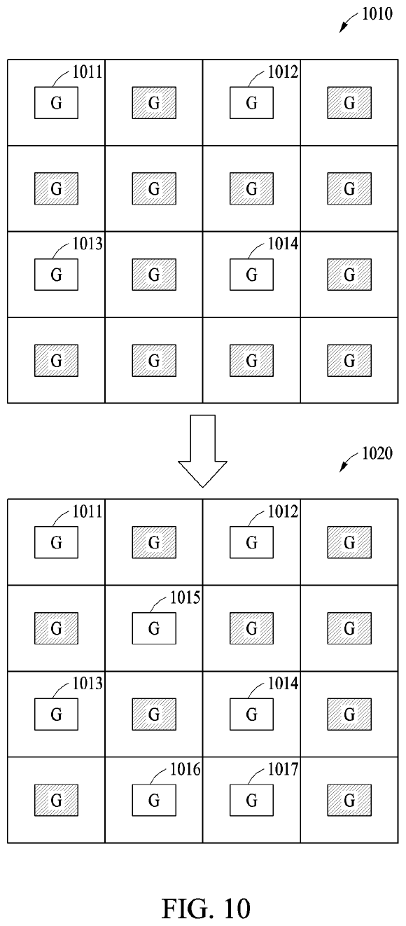

FIG. 10 illustrates an example of a changing process of an original copy of a G channel, according to one or more example embodiments. Referring to FIG. 10, first G channel data 1010 before pixel merging is performed and second G channel data 1020 after pixel merging is performed are illustrated. The first G channel data 1010 and the second G channel data 1020 may correspond to a reference image. The clear G pixels 1011 to 1017 may represent pixels having originality existing from raw data. Other shaded G pixels may represent pixels without originality estimated through interpolation. By comparing the first G channel data 1010 to the second G channel data 1020, these original pixels may exist in each view and thus may be added to the reference image while merging views.

According to examples, a high weight may be assigned to pixels having originality. Equations 9 to 11 shown below may represent fusion weights based on a relationship between the reference view and the other views.

w_{i_d}^{1_2}=w_{i_22}^{1_2}*w_{d_22}^{1_2} [Equation 9]

w_{i_d}^{1_3}=w_{i_22}^{1_3}*w_{d_22}^{1_3} [Equation 10]

w_{i_d}^{1_2}=w_{i_22}^{1_2}*w_{d_22}^{1_2} [Equation 11]

Equation 12 shown below may represent a new fusion weight additionally considering originality to the existing fusion weights of Equations 9 to 11.

w_{i_d}^{1_final}=Σᵢw_{i_d}^{1_i}*wₒⁱ [Equation 12]

In Equation 12, w_{i_d}^{1_final} may denote a new fusion weight and wₒⁱ may denote a originality weight. wₒⁱ may represent a higher weight in the case where a target pixel has originality compared to the case where the target pixel does not have originality. When w_{i_d}^{1_final} applies to Equation 8 shown above, pixel merging based on the first weight based on the pixel intensity difference, the second weight based on the pixel distance, and the third weight based on the originality may be performed.

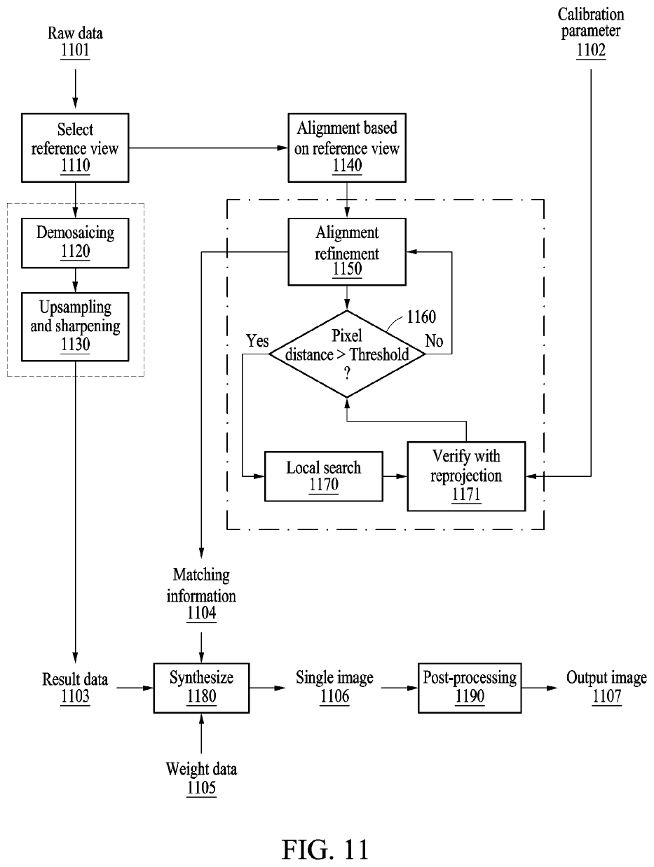

FIG. 11 illustrates an example of an array image processing process according to one or more example embodiments. Referring to FIG. 11, in operation 1110, a reference view may be selected from views of raw data 1101. In operation 1120, demosaicing 1120 based on the raw data 1101 may be performed and in operation 1130, upsampling and sharpening 1130 based on result data of demosaicing 1120 may be performed. Result data 1103 may be determined based on the upsampling and sharpening 1130. Based on upsampling, each image may be enlarged by 4 times (horizontally 2 times and vertically 2 times). Operations 1120 and 1130 may be performed on each view.

In operation 1140, alignment based on the reference view may be performed. Alignment may be performed based on an optical flow using a neural network model. The optical flow may correspond to a dense optical flow. In operation 1150, alignment refinement may be performed. The optical flow may be refined through alignment refinement. In operation 1160, a pixel distance of matching pairs may be compared to a threshold. Based on the comparison result, a refinement target having a pixel distance greater than the threshold may be selected from the matching pairs, in operation 1170, a local search for geometric consistency refinement for the refinement target may be performed, and in operation 1171, a new pixel of the refinement target may be verified through reprojection. A calibration parameter 1102 may be used for reprojection. The geometric consistency refinement may not require iterative image rectification for depth estimation of each array lens camera. Accordingly, explicit geometric warping and correction may be omitted. When pixel distances of all matching pairs are less than the threshold, alignment refinement may be finished and matching information 1104 may be determined.

In operation 1180, a synthesis of result data 1103 may be performed based on the matching information 1104 and weight data 1105. The synthesis may be performed through pixel fusion between each pixel of the reference view of the result data 1103 and corresponding pixels of the other views. As a result of the synthesis, a single image 1106 may be generated. In operation 1190, post-processing, such as deblurring, may be performed on the single image 1106. Deblurring may include optical blur kernel estimation and blur estimation. A neural network model may be used for deblurring. Based on the post-processing, an output image 1107 may be determined. The output image 1107 may correspond to an RGB image or a Bayer image.

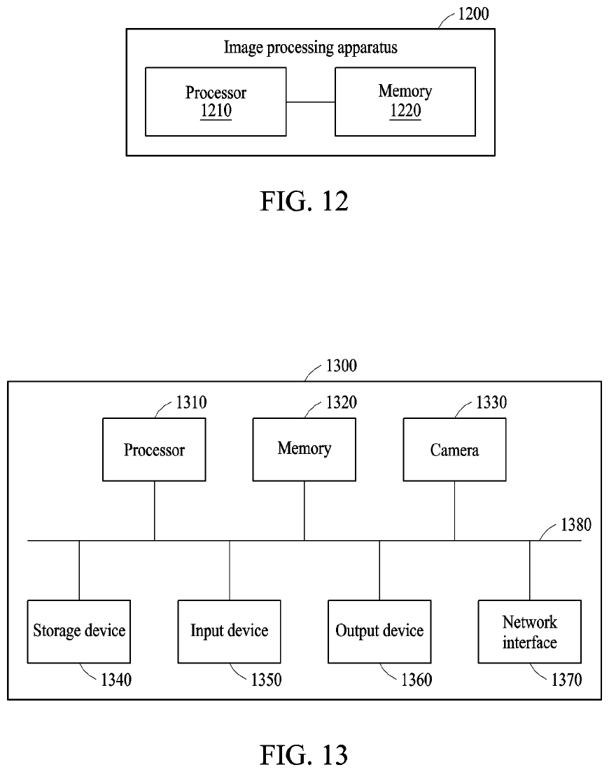

FIG. 12 illustrates an example of a configuration of an image processing apparatus according to one or more example embodiments. Referring to FIG. 12, an image processing apparatus 1200 may include a processor 1210 and a memory 1220. The memory 1220 is connected to the processor 1210 and may store instructions executable by the processor 1210, data to be operated by the processor 1210, or data processed by the processor 1210. The memory 1220 may include a non-transitory computer-readable medium (for example, a high-speed random access memory) and/or a non-volatile computer-readable medium (for example, at least one disk storage device, a flash memory device, or another non-volatile solid-state memory device).

The processor 1210 may execute instructions to perform the operations described herein with reference to FIGS. 1 to 11, FIG. 13, and FIG. 14. For example, the processor 1210 may be configured to receive sub images corresponding to different views of an input array image generated through an array lens, generate temporary restored images based on the sub images by using a gradient between neighboring pixels of each of the sub images, determine an optical flow including matching information based on a view difference between the sub images of pixels of the sub images using a neural network model, based on a pixel distance between matching pairs of the pixels of the sub images based on the matching information, extract refinement targets from the matching pairs, refine the matching information by replacing at least some of target pixels included in the refinement targets based on a local search of a region based on pixel locations of the refinement targets, and generate an output image of a single view by merging the temporary restored images based on the refined matching information. In addition, the description provided with reference to FIGS. 1 to 11, FIG. 13, and FIG. 14 may apply to the image processing apparatus 1200.

FIG. 13 illustrates an example of a configuration of an electronic device according to one or more example embodiments. Referring to FIG. 13, an electronic device 1300 may include a processor 1310, a memory 1320, a camera 1330, a storage device 1340, an input device 1350, an output device 1360, and a network interface 1370 that may communicate with each other via a communication bus 1380. For example, the electronic apparatus 1300 may be implemented as at least a portion of, for example, a mobile device such as a mobile phone, a smartphone, a personal digital assistant (PDA), a netbook, a tablet computer, a laptop computer, and the like, a wearable device such as a smart watch, a smart band, smart glasses, and the like, a home appliance such as a television (TV), a smart TV, a refrigerator, and the like, a security device such as a door lock and the like, and a vehicle such as an autonomous vehicle, a smart vehicle, and the like. The electronic device 1300 may structurally and/or functionally include at least a portion of the imaging device 110 of FIGS. 1A and 1B, the image processing apparatus 120 of FIG. 1A, and the image processing apparatus 1200 of FIG. 12.

The processor 1310 executes functions and instructions for execution in the electronic device 1300. For example, the processor 1310 may process instructions stored in the memory 1320 or the storage device 1340. The processor 1310 may perform operations of FIGS. 1 to 12 and FIG. 14. The memory 1320 may include a computer-readable storage medium or a computer-readable storage device. The memory 1320 may store instructions to be executed by the processor 1310 and may store related information while software and/or an application is executed by the electronic device 1300.

The camera 1330 may capture a photo and/or a video. The camera 1330 may include an array lens assembly. For example, the camera 1330 may include the imaging device 110 of FIGS. 1A and 1B. The storage device 1340 may include a computer-readable storage medium or a computer-readable storage device. The storage device 1340 may store more information than the memory 1320 for a long time. For example, the storage device 1340 may include a magnetic hard disk, an optical disc, a flash memory, a floppy disk, or other types of non-volatile memory known in the art.

The input device 1350 may receive an input from the user in traditional input manners through a keyboard and a mouse and in new input manners such as a touch input, a voice input, and an image input. For example, the input device 1350 may include a keyboard, a mouse, a touch screen, a microphone, or any other device that detects the input from the user and transmits the detected input to the electronic device 1300. The output device 1360 may provide an output of the electronic device 1300 to the user through a visual, auditory, or haptic channel. The output device 1360 may include, for example, a display, a touch screen, a speaker, a vibration generator, or any other device that provides the output to the user. The network interface 1370 may communicate with an external device through a wired or wireless network.

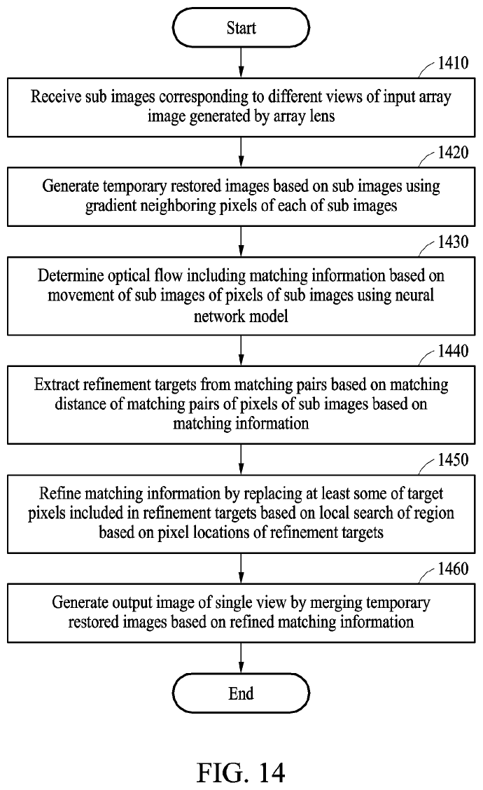

FIG. 14 illustrates an example of an image processing method according to one or more example embodiments. Referring to FIG. 14, in operation 1410, an image processing apparatus may receive sub images corresponding to different views of an input array image generated through an array lens. In operation 1420, the image processing apparatus may generate temporary restored images based on the sub images by using a gradient between neighboring pixels of each of the sub images. In operation 1430, the image processing apparatus may determine an optical flow including matching information based on a view difference between the sub images of pixels of the sub images using a neural network model. In operation 1440, based on a pixel distance between matching pairs of the pixels of the sub images based on the matching information, the image processing apparatus may extract refinement targets from the matching pairs. In operation 1450, the image processing apparatus may refine the matching information by replacing at least some of target pixels included in the refinement targets based on a local search of a region based on pixel locations of the refinement targets. In operation 1460, the image processing apparatus may generate an output image of a single view by merging the temporary restored images based on the refined matching information.

Each of the sub images of the input array image may iteratively include image data in a 2*2 array type arranged in a first channel signal—a second channel signal—the second channel signal—a third channel signal based on a 2*2 CFA, and operation 1420 may include setting an ROI based on pixels in which the second channel signal is dominant among the first channel signal, the second channel signal, and the third channel signal of the sub images, and based on the gradient between the neighboring pixels of the sub images, performing demosaicing by applying interpolation in a smaller gradient direction to pixels included in the ROI and applying interpolation in a larger gradient direction to pixels not included in the ROI. Here, the interpolation may be applied to a smallest gradient direction to pixels included in the ROI and a largest gradient direction to pixels not included in the ROI. The determining of the ROI may include determining a first gradient value based on an interpolation result by using the second channel signal around a first pixel of a first sub image of the sub images and a second gradient value based on and the third channel signal and the first channel signal around the first pixel, and when a difference between the first gradient value and the second gradient value is less than a threshold, setting the ROI based on the first pixel. The performing of the demosaicing may include performing interpolation in a direction indicating a larger gradient of a vertical direction and a horizontal direction of a first pixel of the ROI, and performing interpolation in a direction indicating a smaller gradient of the vertical direction and the horizontal direction of a second pixel outside the ROI.

According to an example embodiment, operation 1420 may include generating color data by performing demosaicing on raw data of the sub images by using edge information based on the gradient between neighboring pixels of each of the sub images, and generating the temporary restored images based on the sub images by performing upsampling using the edge information. According to an example embodiment, operation 1420 may include determining a sharpening filter using the edge information, applying the sharpening filter to the temporary restored images based on a sharpening parameter, and adjusting the sharpening parameter based on a difference between a sharpening result and a target image.

According to an example embodiment, operation 1440 may include extracting at least some of the matching pairs of which a pixel distance is greater than a threshold as the refinement targets.

According to an example embodiment, operation 1450 may include selecting a first refinement target including a first pixel of a first temporary restored image and a second pixel of a second temporary restored image of the temporary restored images from the refinement targets, determining a corresponding pixel, in a real world, to the first pixel by performing undistortion on the first pixel and reprojection to the real world based on a first calibration parameter, determining a temporary pixel of the second temporary restored image by performing reprojection to the second temporary restored image and distortion on the corresponding pixel based on a second calibration parameter, determining a new second pixel of the second temporary restored image by performing a local search based on a location of the temporary pixel in the second temporary restored image, and updating a matching target of the first pixel to the new second pixel.

According to an example embodiment, operation 1460 may include generating the output image based on a weighted sum of each pixel of a reference image of the temporary restored images and a matching pixel of the other images of the temporary restored images based on the refined matching information. The weighted sum of a first pixel of the reference image and a second pixel of the other images may be determined based on a first weight based on a difference between an intensity of the first pixel and an intensity of the second pixel, a second weight based on a pixel distance between the first pixel and the second pixel, and a third weight based on whether the first pixel and the second pixel correspond to raw data.

In addition, descriptions with reference to FIGS. 1 to 13 may apply to the signal processing method of FIG. 14.

The examples described herein may be implemented using hardware components, software components and/or combinations thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or pseudo equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims and their equivalents.

What is claimed is:

1. An image processing method comprising:
receiving a plurality of sub images from an input array image generated through an array lens, each of the plurality of sub images corresponding to different views;
generating a plurality of temporary restored images based on the plurality of sub images using a gradient between neighboring pixels of each of the plurality of sub images;
determining matching information based on a view difference between pixels of the plurality of sub images using a neural network model;
based on a pixel distance between matching pairs of the pixels of the sub images in the matching information, extracting one or more refinement targets from the matching pairs;
refining the matching information to generate refined matching information by replacing at least one of target pixels in the one or more refinement targets based on a local search of a region based on pixel locations of the one or more refinement targets; and
generating an output image of a single view by merging the plurality of temporary restored images based on the refined matching information.

2. The image processing method of claim 1, wherein each of the plurality of sub images of the input array image iteratively comprises image data in a 2*2 array type arranged in a first channel signal—a second channel signal—the second channel signal—a third channel signal format based on a 2*2 color filter array (CFA), and
wherein the generating the plurality of temporary restored images comprises:
setting a region of interest (ROI) based on first pixels in which the second channel signal is dominant among the first channel signal, the second channel signal, and the third channel signal of the sub images; and
based on the gradient between the neighboring pixels of the plurality of sub images, performing demosaicing by applying interpolation in a first gradient direction to second pixels comprised in the ROI and applying interpolation in a second gradient direction to third pixels not in the ROI, the second gradient direction being different from the first direction.

3. The image processing method of claim 2, wherein the setting of the ROI comprises:
determining a first gradient value based on an interpolation result using the second channel signal around a first pixel of a first sub image of the plurality of sub images and a second gradient value based on and the third channel signal and the first channel signal around the first pixel; and
setting the ROI based on the first pixel based on a difference between the first gradient value and the second gradient value being less than a threshold value.

4. The image processing method of claim 2, wherein the performing of the demosaicing comprises:
performing interpolation in the first gradient direction indicating a smaller gradient of a vertical direction and a horizontal direction of a first pixel of the ROI; and
performing interpolation in the second gradient direction indicating a larger gradient of the vertical direction and the horizontal direction of a second pixel outside the ROI.

5. The image processing method of claim 1, wherein the generating of the plurality of temporary restored images comprises:
generating color data by performing demosaicing on raw data of the plurality of sub images using edge information based on the gradient between the neighboring pixels of each of the plurality of sub images; and
generating the plurality of temporary restored images based on the plurality of sub images by performing upsampling using the edge information.

6. The image processing method of claim 5, wherein the generating of the plurality of temporary restored images further comprises:
determining a sharpening filter using the edge information;
applying the sharpening filter to the plurality of temporary restored images based on a sharpening parameter; and
adjusting the sharpening parameter based on a difference between a sharpening result and a target image.

7. The image processing method of claim 1, wherein the extracting of the one or more refinement targets comprises extracting as the one or more refinement targets, at least one of the matching pairs of which a pixel distance is greater than a threshold value.

8. The image processing method of claim 1, wherein the refining of the matching information comprises:
selecting a first refinement target from the one or more refinement targets, the first refinement target comprising a first pixel of a first temporary restored image and a second pixel of a second temporary restored image from among the plurality of temporary restored images;
determining a corresponding pixel, in a real world, to the first pixel by performing undistortion on the first pixel and reprojection to the real world based on a first calibration parameter;
determining a temporary pixel of the second temporary restored image by performing reprojection to the second temporary restored image and distortion on the corresponding pixel based on a second calibration parameter;
determining a new second pixel of the second temporary restored image by performing a local search based on a location of the temporary pixel in the second temporary restored image; and
updating a matching target of the first pixel to the new second pixel.

9. The image processing method of claim 1, wherein the generating the output image comprises generating the output image based on a weighted sum of each pixel of a reference image of the plurality of temporary restored images and a matching pixel of one or more other images of the temporary restored images based on the refined matching information.

10. The image processing method of claim 9, wherein a weighted sum of a first pixel of the reference image and a second pixel of the one or more other images is determined based on a first weight based on a difference between an intensity of the first pixel and an intensity of the second pixel, a second weight based on a pixel distance between the first pixel and the second pixel, and a third weight based on whether the first pixel and the second pixel correspond to raw data.

11. A non-transitory computer-readable storage medium storing instructions that, when executed by a processor, cause the processor to perform the image processing method of claim 1.

12. An image processing apparatus comprising:
a memory configured to store instructions; and
a processor configured to execute the one or more instructions to: receive a plurality of sub images from an input array image generated through an array lens, each of the plurality of sub images corresponding to different views;
generate a plurality of temporary restored images based on the plurality of sub images using a gradient between neighboring pixels of each of the plurality of sub images;
determine matching information based on a view difference between pixels of the plurality of sub images using a neural network model;
based on a pixel distance between matching pairs of the pixels of the sub images in the matching information, extract one or more refinement targets from the matching pairs;
refine the matching information to generate refined matching information by replacing at least one of target pixels in the one or more refinement targets based on a local search of a region based on pixel locations of the one or more refinement targets; and
generate an output image of a single view by merging the plurality of temporary restored images based on the refined matching information.

13. The image processing apparatus of claim 12, wherein each of the plurality of sub images of the input array image iteratively comprises image data in a 2*2 array type arranged in a first channel signal—a second channel signal—the second channel signal—a third channel signal format based on a 2*2 color filter array (CFA), and
wherein the processor is further configured to:
set a region of interest (ROI) based on first pixels in which the second channel signal is dominant among the first channel signal, the second channel signal, and the third channel signal of the sub images, and
based on the gradient between the neighboring pixels of the plurality of sub images, perform demosaicing to generate the plurality of temporary restored images by applying interpolation in a first gradient direction to pixels comprised in the ROI and applying interpolation in a second gradient direction to pixels not comprised in the ROI, the second gradient direction being different from the first direction.

14. The image processing apparatus of claim 13, wherein the processor is further configured to:
perform interpolation in the first gradient direction indicating a smaller gradient of a vertical direction and a horizontal direction of a first pixel of the ROI; and
perform interpolation in the second gradient direction indicating a larger gradient of the vertical direction and the horizontal direction of a second pixel outside the ROI.

15. The image processing apparatus of claim 12, wherein the processor is further configured to extract as the one or more refinement targets, at least one of the matching pairs of which a pixel distance is greater than a threshold value.

16. The image processing apparatus of claim 12, wherein the processor is further configured to:
select a first refinement target from the one or more refinement targets, the first refinement target comprising a first pixel of a first temporary restored image and a second pixel of a second temporary restored image from among the plurality of temporary restored images;
determine a corresponding pixel, in a real world, to the first pixel by performing undistortion on the first pixel and reprojection to the real world based on a first calibration parameter,
determine a temporary pixel of the second temporary restored image by performing reprojection to the second temporary restored image and distortion on the corresponding pixel based on a second calibration parameter,
determine a new second pixel of the second temporary restored image by performing a local search based on a location of the temporary pixel in the second temporary restored image, and
update a matching target of the first pixel to the new second pixel.

17. The image processing apparatus of claim 12, wherein the processor is further configured to generate the output image based on a weighted sum of each pixel of a reference image of the plurality of temporary restored images and a matching pixel of one or more other images of the plurality of temporary restored images based on the refined matching information.

18. The image processing apparatus of claim 17, wherein a weighted sum of a first pixel of the reference image and a second pixel of the one or more other images is determined based on a first weight based on a difference between an intensity of the first pixel and an intensity of the second pixel, a second weight based on a pixel distance between the first pixel and the second pixel, and a third weight based on whether the first pixel and the second pixel correspond to raw data.

19. An electronic device comprising:
an imaging device configured to generate an input array image comprising a plurality of sub images, each of the plurality of sub images corresponding to different views; and
a processor configured to:
generate a plurality of temporary restored images based on the plurality of sub images using a gradient between neighboring pixels of each of the plurality of sub images,
determine matching information based on a view difference between pixels of the plurality of sub images using a neural network model;
based on a pixel distance between matching pairs of the pixels of the sub images in the matching information, extract one or more refinement targets from the matching pairs;
refine the matching information to generate refined matching information by replacing at least one of target pixels in the one or more refinement targets based on a local search of a region based on pixel locations of the one or more refinement targets; and
generate an output image of a single view by merging the plurality of temporary restored images based on the refined matching information.

20. The electronic device of claim 19, wherein each of the plurality of sub images of the input array image iteratively comprises image data in a 2*2 array type arranged in a first channel signal—a second channel signal—the second channel signal—a third channel signal format based on a 2*2 color filter array (CFA), and
wherein the processor is further configured to:
set a region of interest (ROI) based on first pixels in which the second channel signal is dominant among the first channel signal, the second channel signal, and the third channel signal of the sub images, and
based on the gradient between the neighboring pixels of the plurality of sub images, perform demosaicing to generate the plurality of temporary restored images by applying interpolation in a first gradient direction to pixels comprised in the ROI and applying interpolation in a second gradient direction to pixels not comprised in the ROI, the second gradient direction being different from the first direction.
